(19) United States
(12) Patent Application Publication
(10) Pub. No.: US 2026/0049939 A1
(43) Pub. Date: Feb. 19, 2026

(54) Apparatus and A Method for Carrying Out Spectroscopy

(71) Applicant: Lightnovo ApS, Birkerød (DK)

(72) Inventors: Oleksii Ilchenko, Birkerød (DK); Yurii Pilhun, Birkerød (DK)

(73) Assignee: Lightnovo ApS, Birkerød (DK)

(21) Appl. No.: 18/804,586

(22) Filed: Aug. 14, 2024

(51) Int. Cl. G01N 21/65

(52) U.S. Cl. CPC G01N 21/65; G01N 2201/0612; G01N 2201/0635; G01N 2201/104

(57) ABSTRACT

An apparatus for carrying our spectroscopy configured to obtain a spectrum beam from an interaction between a laser beam and a sample. The apparatus includes an optical system that guides the spectrum beam to a diffraction element of the optical system that is configured to split the spectrum beam into a spectrum of spatially separated wavelength components associated with the sample. A detector with an array of pixels for detecting the spectrum of spatially separated wavelength components on pixels of the array of pixels and a data acquisition device coupled to the detector. The data acquisition device carries out measurements, wherein during each measurement data indicative of the spectrum of spatially separated wavelength components is obtained from the detector, wherein the spectrum of spatially separated wavelength components is detected, and determine an averaged spectrum of the sample based on the data obtained during at least some measurements.

### BACKGROUND OF THE INVENTION

### Field of the Invention

The present disclosure relates to an apparatus and a method for carrying out spectroscopy.

### Related Art

Spectroscopy is a useful tool to examine a sample. Spectroscopy, such as Raman spectroscopy, is also very useful to identify a sample based on a sample's spectral fingerprint or to determine a chemical composition of the sample based on the components'spectral fingerprints. The discovery of the Raman effect in 1928 has aided to the fundamental understanding of the quantum nature of light and matter interaction, and has also opened up completely novel areas of optics and spectroscopic research that has accelerated greatly during the last decade. The utility of Raman spectroscopy has been demonstrated for a diverse range of biological, biomedical and chemical applications, such as chemical imaging of living cells and tissues, stem cell and cancer research, bacterial identification, chemical hazards and illicit substances detection, as well as food and product authentication, and with a great deal of interest and research into its potential for disease diagnosis in the laboratory and in-vivo.

Raman spectroscopy has been developed into a variety of methods and experimental realizations, such as confocal Raman microscopy, Raman endoscopy, spatially offset Raman spectroscopy (SORS), resonance Raman spectroscopy, and surface enhanced Raman spectroscopy (SERS). The listed Raman spectroscopy and microscopy methods are non-destructive, label-free, non-invasive, and capable of providing 3D molecular sensing with depth profiling. Such capabilities, however, come at the cost of extremely high requirements for instrumentation, such as the used laser should have stable wavelength and stable high optical power, and the spectroscopic sensor should have low noise. Therefore, Raman spectroscopy and microscopy applications that require high spectral resolution and sensitivity would normally need to be performed on high-end, bulky, and costly Raman instruments. The need for miniaturization of Raman instrumentation is driven by applications where the complexity and/or the bulkiness of existing devices is obstructive. Application examples in need of miniaturization include space exploration, on-site toxic substance inspection, in-vivo diagnostics of tissues, chemical identification in hardly accessible places using robots and drones, and Raman device integration into robotic arms for biomedical applications.

Systems and methods for carrying out Raman spectroscopy are described in US 2021072158 A1, the content contents of which are incorporated herein by reference.

It is an object of the present disclosure to provide an improved apparatus and method for carrying out spectroscopy, in particular Raman spectroscopy.

### SUMMARY

In one aspect, the present disclosure relates to an apparatus for carrying out spectroscopy, in particular Raman spectroscopy, on a sample. The apparatus is configured to obtain a spectrum beam from an interaction between a laser beam and a sample. The apparatus includes an optical system configured to guide the spectrum beam to a diffraction element of the optical system, such as a grating. The diffraction element is configured to split the spectrum beam into a spectrum of spatially separated wavelength components associated with the sample. The apparatus includes a detector with an array of pixels for detecting the spectrum of spatially separated wavelength components on pixels of the array of pixels and a data acquisition device coupled to the detector. The data acquisition device is configured to carry out a sequence of measurements using the detector, wherein during each measurement data which is indicative of the spectrum of spatially separated wavelength components is obtained from the array of pixels of the detector, wherein in different measurements the spectrum of spatially separated wavelength components is detected on different pixels of the array of pixels. The data acquisition device is further configured to determine an averaged spectrum of the sample based on the data obtained during at least some measurements and preferably during all measurements of the series of measurements.

The sample is, however, not part of the apparatus, and it may be arranged in the optical system of the apparatus such that it can be hit by the laser beam. The spectrum beam generated by interaction between the laser beam and the sample can be guided by the optical system via the grating to the detector. At least in some embodiments, the spectrum beam is only the portion of scattered light from the interaction, which is picked up by the optical system and guided to the detector.

As at least in some embodiments, the average spectrum of the sample is determined from the data that is obtained during the measurements of the series of measurements on different pixels of the array of pixels, pixel-to-pixel QE variation may be averaged out and a spectrum of the sample with an improved signal to noise ratio (SNR) may be obtained.

In some embodiments, the apparatus is configured to move the laser beam with respect to the array of pixels in between consecutive measurements, such that different pixels of the array of pixels are hit by the spectrum of spatially separated wavelength components in different measurements.

In some embodiments, the apparatus is configured to move the pixel array of the detector with regard to the incident spectrum of spatially separated wavelength components in different measurements, such that different pixels of the array of pixels are hit by the spectrum of spatially separated wavelength components in different measurements.

In some embodiments, the data acquisition device is configured to control a movement of the laser wavelength and consequent a shift of the incident spectrum beam with respect to the array of pixels in between consecutive measurements. In some embodiments, the data acquisition device is configured to control the position and/or a shift of the incident spectrum on the array of pixels. In some embodiments, the data acquisition device is configured to control the movement of the pixel array of the detector with regard to the incident spectrum. The movement may be controlled in such a way that from measurement to measurement, the spectrum is shifted by a defined number of rows on the arrays of pixels or that the detector is moved or rotated in a defined way from measurement to measurement.

At least in some embodiments, a controlled movement and thus a change of position of the incident spectrum with respect to the array of pixels or the movement of the pixel array of the detector with regard to the incident spectrum only takes place in between measurements. This may help to improve the signal to noise ratio of a detected signal, as a signal that could be detected in a single pixel is not distributed over several pixels due to a movement of the incident spectrum with respect to the array of pixels or a movement of the array of pixels with regard to the incident spectrum.

In some embodiments, the laser beam is provided by a laser. In some embodiments, the laser is at least one of the following: a non-wavelength stabilized laser, a non-temperature stabilized laser, a tunable laser, a diode laser. In some embodiments, the laser is a stabilized laser, such as a wavelength and/or temperature-stabilized laser.

In some embodiments, the data acquisition device is configured to change the wavelength of the laser beam. In some embodiments, the laser may be a wavelength tunable laser and the data acquisition device may be coupled to the laser such that it can control the wavelength of the laser beam provided by the laser.

In some embodiments, the apparatus includes a carrier for the detector, wherein the carrier is configured to move or rotate the detector with regard to the incident spectrum of spatially separated wavelength components. In some embodiments, the carried is connected to the data acquisition device such that the data acquisition device may control the carrier for moving or rotating the detector.

In some embodiments, the carrier is configured to rotate the array of pixels with regard to a center of the grating.

In some embodiments, the apparatus includes a support for holding the diffraction element, wherein the support holds at least one further diffraction element and is configured such that it can move the diffraction element out of the optical system and position the further diffraction element in the optical system.

In some embodiments, the support includes a rotatable wheel having mountings for diffraction elements at different locations which are offset from each other as viewed in the circumferential direction of the rotatable wheel. The rotatable wheel may be arranged such that a diffraction element, which is arranged in one of the mountings, can be positioned in the optical system by a rotational movement of the wheel. In some embodiments, the rotating wheel is a turret.

In some embodiments, during operation of the apparatus, the spectrum of spatially separated wavelength components passes through at least one lens of the optical system, such as a collimation or focusing lens. In some embodiments, the lens is arranged before the grating, such as between a slit and the grating, and the lens is coupled to a drive, for example a stepper motor, wherein the drive is used to change the position of the lens, wherein a change of position of the lens causes a movement and thus a change of position of the spectrum of spatially separated wavelength components with respect to the array of pixels of the detector. For the change of position, the lens may be moved in a direction perpendicular to the optical axis of the lens.

In some embodiments, the data acquisition device is configured to control the drive to synchronize the change of position of the lens with a measurement of the series of measurements.

In some embodiments, the grating spreads the spectrum of spatially separated wavelength components in a spectral direction, and the optical system is configured to compress a width direction of the spectrum to a predetermined width on the array of pixels, wherein the width direction of the spectrum is perpendicular to the spectral direction.

In some embodiments, the predetermined width is in the range of one to fifty pixels or corresponds to a size of a pixel of the detector or a multiple of the pixel size.

In some embodiments, the apparatus is configured to move the incident spectrum or the array of pixels such that the spectrum of spatially separated wavelength components is moved by a defined distance on the array of pixels.

In some embodiments, the apparatus includes a reference sample arranged in the optical system, the apparatus being configured to split the laser beam in a first portion and a second portion, the first portion of the laser beam being the laser beam used for the interaction with the sample to obtain the spectrum beam, which is a first spectrum beam;
the apparatus being further configured to obtain a second spectrum beam from an interaction between the second portion of the laser beam and the reference sample and the optical system being configured to guide the second spectrum beam to the diffraction element, which splits the second spectrum beam into a reference spectrum of spatially separated wavelength components associated with the reference sample;
the data acquisition device being configured:
to obtain, during each measurement, second data which is indicative of the reference spectrum of spatially separated wavelength components from the array of pixels of the detector, wherein in different measurements the second data is obtained on different pixels than the first data obtained for the spectrum of the sample; and to use the second data obtained in a measurement for calibrating the first data obtained in the same measurement for the spectrum of spatially separated wavelength components of the sample.

In one aspect, the present disclosure relates to a computer implemented method of carrying out spectroscopy, in particular Raman spectroscopy, on a sample, using an apparatus configured to obtain a spectrum beam from an interaction between a laser beam and a sample, the apparatus including an optical system configured to guide the spectrum beam to a diffraction element of the optical system, such as a grating, the diffraction element being configured to split the spectrum beam into a spectrum of spatially separated wavelength components associated with the sample, and the apparatus including a detector with an array of pixels for detecting the spectrum of spatially separated wavelength components on pixels of the array of pixels and a data acquisition device coupled to the detector,
wherein the method includes:
carrying out a sequence of measurements using the detector, wherein in each measurement data which is indicative of the spectrum of spatially separated wavelength components is detected on the array of pixels, wherein in different measurements the spectrum of spatially separated wavelength components is detected on different pixels of the array of pixels, and
determining an averaged spectrum of the sample based on the data obtained during at least some measurements and preferably during all measurements of the series of measurements.

In another aspect, the present disclosure relates to the use of embodiments of the apparatus as described herein for determining an optical spectrum of a sample or for identifying the sample.

In one aspect, the present disclosure relates to an apparatus for carrying out spectroscopy, in particular Raman spectroscopy, on a sample,
the apparatus being configured to obtain a first spectrum beam from an interaction between a first portion of a laser beam and a sample and a second spectrum beam from an interaction between a second portion of the laser beam and a known reference sample, the apparatus being further configured to guide the first spectrum beam and the second spectrum beam to a diffraction element of the apparatus, such as a grating;
the diffraction element being configured to split the first spectrum beam into a first spectrum of spatially separated wavelength components associated with the sample and to split the second spectrum beam into a second spectrum of spatially separated wavelength components associated with the reference sample,
the apparatus including a detector with an array of pixels, the apparatus, in particular a data acquisition device of the apparatus, being configured:
to carry out a sequence of measurements using the detector, wherein, simultaneously in each measurement of the sequence of measurements, first data which is indicative of the first spectrum of spatially separated wavelength components is detected by the array of pixels of the detector and second data which is indicative of the second spectrum of spatially separated wavelength components is detected by the array of pixels, wherein for each measurement the first data is collected in different pixels than the second data, and
to determine at least a portion of the first spectrum of spatially separated wavelength components associated with the sample by use of the first data and the second data obtained during at least some measurements and preferably during all measurements of the series of measurements.

In some embodiments, in different measurements of the sequence of measurements, at least one of the first data and the second data is collected in different pixels.

In some embodiments, the apparatus, in particular the data acquisition device, is configured to carry out a wavelength calibration on the first data obtained during a measurement by use of the second data obtained simultaneously during the same measurement, thereby obtaining wavelength calibrated first data and/or a wavelength calibrated spectrum of the sample.

In some embodiments, the apparatus, in particular the data acquisition device, is configured to determine at least a portion of the spectrum of the sample by use of the wavelength calibrated first data determined for the at least some and preferably for all measurements of the series of measurements.

In some embodiments, the apparatus, in particular the data acquisition device, is configured to determine at least a portion of an averaged spectrum of the sample by use of the first data determined for the at least some and preferably for all measurements of the series of measurements.

In some embodiments, the apparatus, in particular the data acquisition device, is configured to determine at least a portion of an averaged spectrum of the sample by averaging the spectra determined from the wavelength calibrated first data of at least some and preferably of all measurements of the series of measurements.

In some embodiments, the apparatus, in particular the data acquisition device, is configured:
to detect simultaneously, in each measurement of the sequence of measurements, the first data in a first set of pixels of the detector and the second data in a second set of pixels of the detector, wherein the first set of pixels is different from the second set of pixels and wherein the sets of pixels change or may change from measurement to measurement during the sequence of measurements.

In some embodiments, the apparatus includes an optical system configured to compress a width of the first spectrum and a width of the second spectrum at the location of the detector to a value which is in the range of the size of a pixel and preferably lower than the pixel size, wherein, for example, the pixel size is 4 μm, wherein the width is measured in a plane of the pixel surface and in a direction which is orthogonal to a spectral direction of the spectra.

In some embodiments, the apparatus includes at least one laser for providing a laser beam and a beam splitter for splitting the laser beam, thereby generating the first portion and the second portion of the laser beam.

In some embodiments, the laser is at least one of the following: a non-wavelength stabilized laser, a non-temperature stabilized laser, a tunable laser, a diode laser.

In some embodiments, the wavelength of the laser beam is changed or allowed to change during the sequence of measurements.

In some embodiments, the detector is moveable or rotatable with regard to the first spectrum and the second spectrum that are incident on the array of pixels of the detector.

In some embodiments, the apparatus is configured to synchronize a movement or rotation of the detector with the series of measurements.

In some embodiments, the first spectrum and the second spectrum are moveable transversely to the array of pixels of the detector in at least one direction.

In some embodiments, the first spectrum beam and the second spectrum beam pass through a lens, such as a collimation or focusing lens, of the apparatus, the lens being arranged to in the optical system before the grating and the lens being coupled to a drive, for example a stepper motor, wherein a movement of the lens causes a movement of the first spectrum and the second spectrum with respect to the array of pixels of the detector.

In some embodiments, the apparatus is configured to control the stepper motor to synchronize the movement of the lens with a measurement of the series of measurements.

In some embodiments, at least one of the first portion of the laser beam and the first spectrum beam does not interact with the reference sample.

In some embodiments, at least one of the second portion of the laser beam and the second spectrum beam does not interact with the sample.

In some embodiments, the first portion of the laser beam travels along a light path through the apparatus which runs offset to a light path of the second portion of the laser beam.

In some embodiments, a light path of the first spectrum beam runs offset to a light path of the second spectrum beam.

In one aspect, the present disclosure relates to a method of carrying out spectroscopy, in particular Raman spectroscopy, on a sample,
wherein the method uses an apparatus which is configured to obtain a first spectrum beam from an interaction of a first portion of a laser beam and a sample, which is arranged in the apparatus, and a second spectrum beam from an interaction between a second portion of the laser beam and a known reference sample, which is also arranged in the apparatus, the apparatus being further configured to guide the first spectrum beam and the second spectrum beam to a diffraction element of the apparatus, which splits the first spectrum beam into a first spectrum of spatially separated wavelength components associated with the sample and which splits the second spectrum beam into a second spectrum of spatially separated wavelength components associated with the reference sample,
wherein the method includes:
detecting repeatedly, by use of the detector, in a sequence of measurement and simultaneously in each measurement of the sequence of measurements, first data which is indicative of the first spectrum of spatially separated wavelength components on the array of pixels of the detector and second data which is indicative of the second spectrum of spatially separated wavelength components in different pixels on the array of the pixels, and
determining at least a portion of the first spectrum of spatially separated wavelength components associated with the sample by use of the first data and the second data obtained during at least some measurements and preferably during all measurements of the series of measurements.

The sample and the reference sample can be arranged for measurements in the apparatus, in particular, at respective predetermined locations in the optical system of the apparatus. At least one of the sample and reference sample can also be arranged outside the apparatus, in particular outside a housing of the apparatus, but such that the at least one of the sample and reference sample can be arranged in or reachable by the optical system of the apparatus. Arranging the sample outside the apparatus can be helpful for quickly changing the sample. Furthermore, the sample may be a liquid, for example a liquid in a container.

Features that are mentioned in connection with a device claim and that reflect a process step may also be included in a method claim.

Embodiments of the present disclosure may relate to a system comprising one or more processors; and one or more memories storing computer-readable instructions that, upon execution by the one or more processors, configure the system to carry out at least some of the steps of one of the methods as described herein. For example, a computer device as described herein may include one or more processors, and/or and one or more memories storing computer-readable instructions that, upon execution by the one or more processors, configure the system to carry out at least some of the steps of one of the methods as described herein. As another example, a data acquisition device as described herein may include one or more processors, and/or and one or more memories storing computer-readable instructions that, upon execution by the one or more processors, configure the system or device to carry out at least some of the steps of one of the methods as described herein.

Furthermore, embodiments of the present disclosure may relate to one or more non-transitory computer-readable storage media storing instructions that, upon execution on a system, cause the system to perform operations in order to carry out at least some of the steps of one of the methods as described herein.

### BRIEF DESCRIPTION OF THE DRAWINGS

The following detailed description, given by way of example, but not intended to limit the invention solely to the specific embodiments described, may best be understood in conjunction with the accompanying drawings, incorporated herein by reference, wherein:

FIG. 1A shows an optical layout and working principle of an exemplary apparatus for carrying out spectroscopy.

FIG. 1B shows a reference sample on a filter/slit of the apparatus of FIG. 1A.

FIG. 1C and FIG. 1D show sensor images that demonstrate simultaneous acquisition of main and reference Raman signals from laser excitation at 785 nm (c) and 660 nm (d). The images represent a Raman spectrum of water-ethanol solution (60:40) in the main channel and a Raman spectrum of polystyrene in the reference channel.

FIG. 2A shows an image of the sensor with a sample spectrum focused into a line with the width of 1 pixel.

FIG. 2B shows another image of the sensor with a sample spectrum focused into a line with the width of 20 pixels.

FIG. 2C shows a SERS spectrum of BPE obtained after the averaging of 3 rows of the image in FIG. 2A.

FIG. 2D shows a SERS spectrum of BPE obtained after the averaging of 20 rows of the image in FIG. 2B.

FIG. 2E is an illustration of the dynamic quantum efficiency (QE) variation of pixels on the sensor.

FIG. 2F and FIG. 2G each shows a fluorescence spectrum from a glass cover slide excited by a laser with excitation wavelength of 785 nm obtained after averaging of 10 repetitions without pixel averaging method (FIG. 2F) and with pixel averaging method (FIG. 2G) demonstrating an improved SNR ratio for the spectrum shown in FIG. 2G.

FIGS. 3A-3D show various set-ups for rotation of the sensor of an apparatus for carrying out Raman spectroscopy.

FIG. 4 shows Raman spectra of glucose solution in water at concentration 1 g/L, black curve—raw spectrum, thinner black curve where the sensor along a spectral dimension (corresponding in some embodiments to CCD rows) at 11 camera tilt positions.

FIG. 5 shows an enlarged view of a portion of the spectrum of FIG. 4.

FIG. 6 shows another exemplary embodiment of a Raman spectrometer.

FIG. 7 illustrates that a movement of a stepper motor for moving a lens in the apparatus of FIG. 6 can be synchronized with spectrum acquisition.

FIG. 8 illustrates pixel correction and fringe correction on the fluorescence spectrum of glass from 785 nm laser excitation.

FIGS. 9A and 9B show various views of another exemplary embodiment of an apparatus with rotating sensor unit and transmissive Bragg gratings as dispersive elements.

FIG. 10 shows an exemplary data acquisition device coupled to a detector;

FIG. 11 shows a block diagram of an embodiment of an apparatus for spectroscopy.

### DETAILED DESCRIPTION

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of’ and “consists essentially of’ have the meaning ascribed to them in U.S. Patent law, e.g., they allow for elements not explicitly recited, but exclude elements that are found in the prior art or that affect a basic or novel characteristic of the invention. These and other embodiments are disclosed or are obvious from and encompassed by, the following Detailed Description.

Embodiments of an apparatus for carrying out optical spectroscopy can be denoted in the following also as Raman system or miniaturized Raman system or Raman spectrometer.

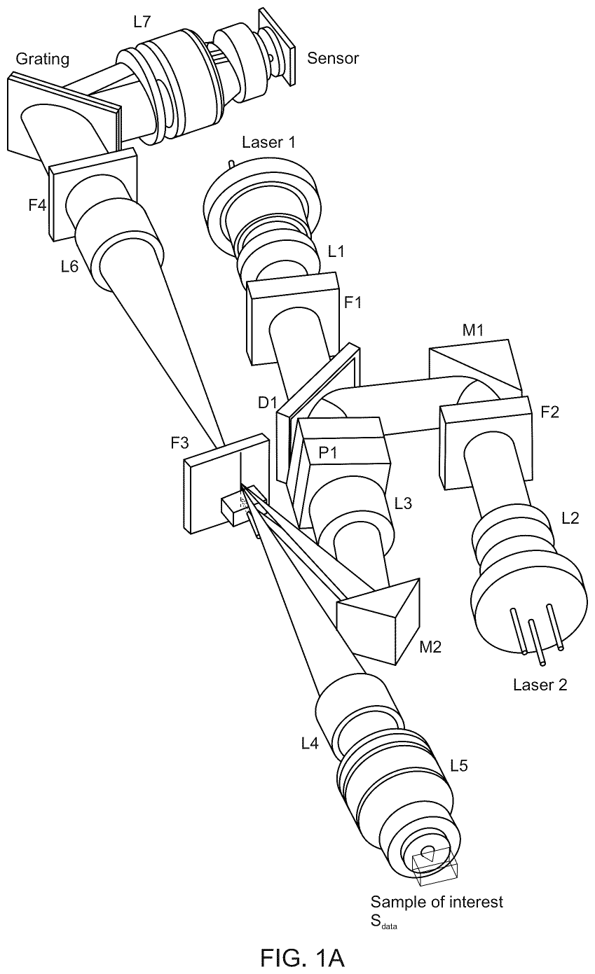

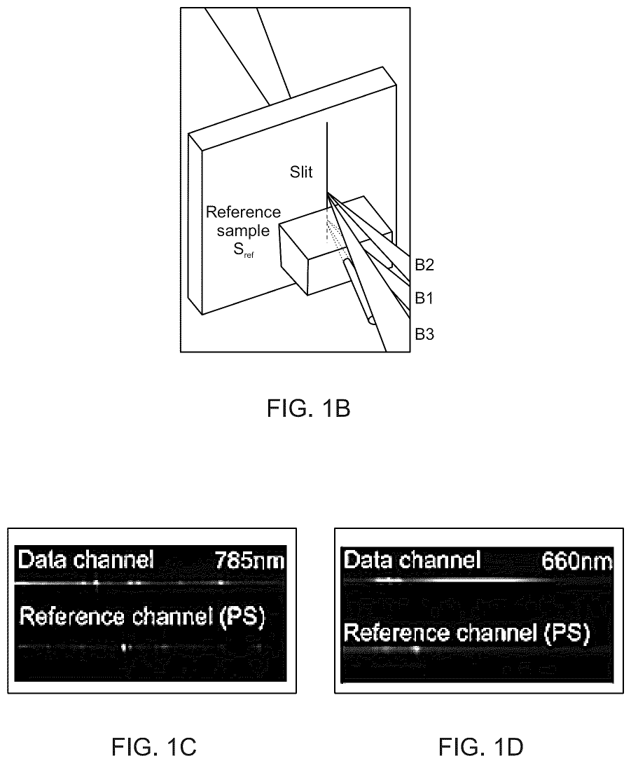

FIG. 1A shows an optical scheme of an exemplary embodiment of a Raman spectrometer. It includes a laser 1, such as an AlGaAs laser diode (AlGaAs=Aluminium Gallium Arsenide). In some embodiments, the laser diode is arranged in a TO package, for example with a diameter of 5.6 mm, and includes a Fabry-Pérot resonator at a central wavelength of 785 nm and a maximum power of 200 mW. The laser is used as a Raman source (L1). In some embodiments, the laser spectral linewidth at half maximum (LWHM) is 0.2 nm which is at least in some embodiments sufficient to obtain a spectral pixel resolution of the miniaturized Raman system of 0.3 nm. In some embodiments, a selected type of diode laser may require precise temperature stabilization for Raman spectroscopy applications to prevent laser wavelength drift and/or a change of a laser mode. Such a change is also called a “mode hop”. However, in order to avoid bulky, costly and power consuming Peltier elements for temperature stabilization of the laser diode, at least in some embodiments the described Raman system does not require laser wavelength stabilization.

As shown in FIG. 1A, a collimated laser beam provided by laser 1 is split into two beams using prism (P1), resulting in a portion of the laser beam (B1) and another portion of the laser beam (B2). The portion of the laser beam, also denoted as a part of the split beam B1, is focused on a reference sample, in particular a polystyrene reference sample, that is glued to a Raman edge filter (F3). In some embodiments, the Raman edge filter (F3) is coated with an aluminium mask. The mask serves as a spectral slit. The coating forming the aluminium mask is in particular arranged on one surface of the filter. In other embodiments, the slit is not arranged on a front side of a filter, but on the opposite or back side of the filter.

The other portion of the laser beam (B2), also denoted as another part of the split beam B2, is focused on the slit and reflected from the Raman edge filter (F3) towards a sample of interest Sdata. From the sample, a first spectrum beam (B3) (see also FIG. 1B) is obtained due to interaction, in particular Raman interaction, between the sample and the incident beam. A second spectrum beam is obtained from an interaction between the reference sample and the part of the split beam (B1).

As a result, two beams are obtained whereof one beam includes the Raman spectrum of the sample, while the other beam includes the Raman spectrum of the reference sample. The beam that carries the Raman spectrum from the sample is also denoted as a first spectrum beam and the beam that carries the Raman spectrum from the reference sample is also denoted as a second spectrum beam. The Raman spectra from both beams in the “fingerprint” range (400-2700 cm−1) are simultaneously collected by a sensor, such as a NIR enhanced imaging sensor in the range 800-960 nm (see FIG. 1C). The sensor includes an array of pixels for detecting the Raman spectra.

The optical system of the apparatus of FIG. 1A is such that the two Raman beams travel slightly offset from each other and the Raman spectra are collected in different areas on the pixel array of the detector. The first spectrum beam and the second spectrum beam can be regarded as two detection channels, namely a main or data channel associated with the first spectrum beam that includes the Raman spectrum of the sample and a reference channel associated with the second spectrum beam that includes the Raman spectrum of the reference channel, and the two channels are detected in different areas of the pixel detector.

The optical system for guiding the first spectrum beam and the second spectrum beam is also denoted as Raman beam delivery system. It includes or consists of a reference sample Sref, a lens L5, also called Raman probe L5, a slit lens (L4) and a spectrometer. The spectrometer includes or consists of the following optical elements: a slit, filter F3, lens L6, filter F4, a grating, focusing lens L7, and a sensor.

In some embodiments, a spectral slit size provided by the spectrometer is 25 μm, which is zoomed down to 5.4 μm on the focal plane, which is on the array of the sensor having a binned pixel size of 4 μm. The imaging capabilities of lens L7 provide uniform resolution along the spectral dimension on the sensor at or close to diffraction limited spot size. This makes it possible to concentrate most of the Raman signal intensity into a single row on the sensor (see FIG. 1C and FIG. 1D). The sensor providing the array of pixels is in some embodiments a CMOS sensor. CMOS=complementary metal-oxide semiconductor.

In some embodiments, the spectrometer is equipped with fused silica transmission Bragg grating with average efficiency in the first order of diffraction ˜96% in the range of 800-960 nm. In combination with NIR coating for all optical elements, the entire optical system provides extremely high throughput from the sample to the detector of about 92%. The described elements may significantly boost the sensitivity of miniaturized Raman spectrometer.

In some embodiments, in order to cover a “high frequency” Raman range, an extra laser 2, such as a laser diode, such as an AlGaInP laser diode with a Fabry-Perot resonator L2 with a central wavelength of 675 nm, LWHM 0.2 nm and a maximum power of 200mW is provided (AlGaInP=Aluminium Gallium Indium Phosphide). In some embodiments, the additional laser (L2) and the main laser (L1) are switched on sequentially, providing two different Raman shift ranges with the same grating.

The Raman beams generated by the additional laser due to interaction of split beams generated from the additional, second laser and the sample and reference sample can be obtained in different areas of the sensor. The proposed approach makes it possible to collect in the “high frequency” Raman range by the same optical elements in the same spectral range 800-960 nm that is used for collection of the “fingerprint” range. This strategy allows to maintain a high SNR (SNR=signal to noise ratio) for Raman spectra in “high frequency” range due to relatively high QE (QE=quantum efficiency) of the sensor (60% at 840 nm, 40% at 940 nm) in the range 800-960 nm.

The collimated beam from the second laser, for example a non-temperature-stabilized diode laser (L2), is combined and co-aligned with the collimated beam from the first laser (L1) by dichroic mirror D1. After the dichroic mirror D1, laser irradiation from the second laser (L2) propagates through the same optical path as B1-B3 and targets the polystyrene sample on the slit Sref and sample of interest Sdata. Two Raman spectra of the main channel and the reference channel in the range of 2700-4000 cm⁻¹ are collected by the imaging sensor (FIG. 1D). Therefore, in some embodiments, the miniaturized Raman spectrometer is capable of collecting combined Raman spectrum in the range of 400-4000 cm⁻¹ reaching the performance typically associated with much larger, research grade systems.

In some embodiments, the signals in the data channels obtained from a laser, for example at 785 nm, and from a second laser, for example at 660 nm as in the described embodiment, are collected one by one, not simultaneously, as their spectral lines may overlap on the pixel array of the sensor. However, after two or more measurements, the obtained data may be automatically processed and appended by software, executed by the data acquisition device, to provide one spectrum covering a range from 400-4000 cm⁻¹.

At least in some embodiments, the sensitivity of the Raman spectrometer (see FIG. 1A) also depends on the dark noise of the detector, which is different from QE variation of the pixels. Dark noise is sometimes also called dark current. It can be caused by electric charges generated in the detector when no outside radiation is impinging on the pixel array of the detector.

Due to the weakness of a detected Raman signal, in some embodiments, the spectrometer can be equipped with cooled linear or imaging sensors with relatively large pixel size (12-25 μm). Sensor cooling reduces the dark noise whereas large pixel size allows collecting more photons maintaining high resolution at the same time. Nevertheless, this is a high power demanding and bulky approach.

At least in some embodiments, the apparatus as shown in FIG. 1A is configured to carrying out Raman spectroscopy on the sample of interest (Sdata). In operation, the apparatus obtains on the sensor a first spectrum beam from an interaction between a portion of the split laser beam and the sample of interest. Furthermore, the apparatus obtains a second spectrum beam from an interaction between a portion of the laser beam and a known reference sample, which can be polystyrene. The optical system of the apparatus is configured to guide the first spectrum beam and the second spectrum beam to a diffraction element of the apparatus, such as a grating or transmission grating. The first spectrum beam provides a signal in the main or data channel and the second spectrum beam provides a signal in the reference channel.

In the apparatus, the diffraction element, which is a transmission grating in the shown example of FIG. 1A, is configured to split the first spectrum beam into a first spectrum of spatially separated wavelength components associated with the sample and to split the second spectrum beam into a second spectrum of spatially separated wavelength components associated with the reference sample. The first spectrum provides the Raman spectrum of the sample of interest and the second spectrum relates to the Raman spectrum of the reference sample. Due to the grating, light of different wavelengths is diffracted in different directions, so that different wavelengths in the spectrum appear at different positions on the pixel array of the sensor. The positions are offset from each other when viewed in a spectral direction (also called spectral dimension), which corresponds to the horizontal direction in FIG. 1C and FIG. 1D, which show a picture of the detector array for the main channel (denoted as data channel in FIG. 1C and FIG. 1D).

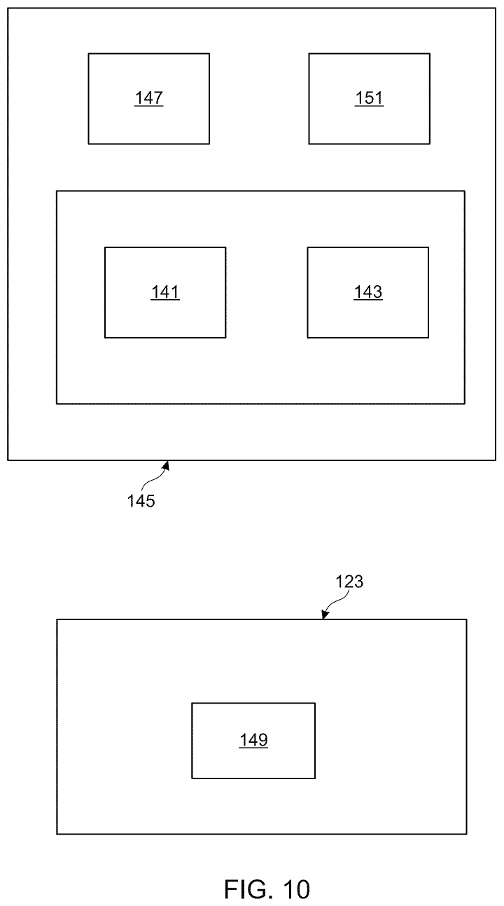

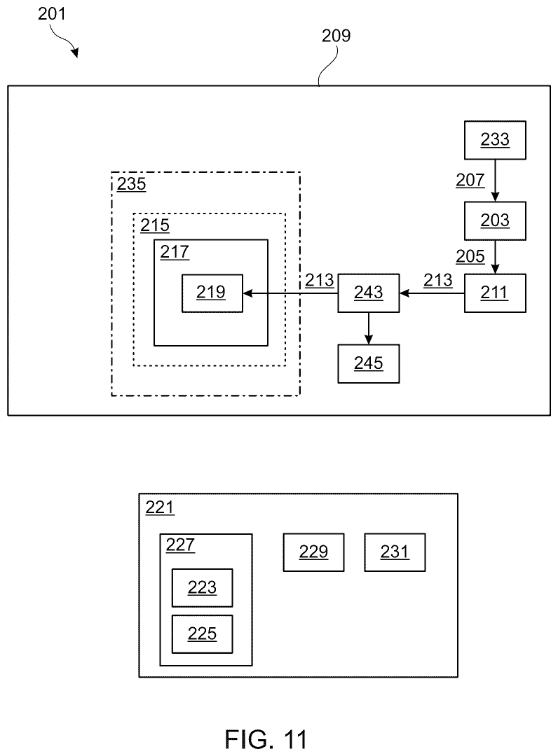

As shown in FIG. 10, the apparatus includes a data acquisition device 127, such as a computer system, which is coupled to the sensor 123 and which can in particular receive measured data from the sensor 123. The data acquisition device 127 is configured to carry out a sequence of measurements using the sensor 123. The data acquisition device 127 includes a storage 145 and a central processing unit CPU 147. In some embodiments, the CPU 147 can execute a computer program code, which is configured to carry out the procedure described below automatically.

In operation, the data acquisition device 127 determines simultaneously in each measurement of the sequence of measurements first data 141 which is indicative of the first spectrum of spatially separated wavelength components by use of the array of pixels 149 of the sensor 123 and second data 143 which is indicative of the second spectrum of spatially separated wavelength components, wherein for each measurement the first data 141 is collected in different pixels than the second data 143. As described above, this is at least in some embodiments due to the optical system by which the first spectrum beam is guided differently through the optical system that the second spectrum beam and thus the spectra appear in different locations on the array of pixels 149. The obtained data 141, 143 may be stored on storage 145.

Further in operation, the data acquisition device 127 further determines at least a portion of the first spectrum of spatially separated wavelength components associated with the sample by use of the first data 141 and the second data 143 obtained during at least some measurements and preferably during all measurements of the series of measurements. The second data 143 may in particular be used for calibration purposes.

In some embodiments, the first data 141 can provide for each measurement an intensity value measured at a pixel for each pixel of the array of pixels 149. Thus, the first data 141 may reflect an intensity distribution, which is measured by the individual pixels of the pixel array 149. Correspondingly, the second data 143 can provide for each measurement an intensity value measured at a pixel for each pixel of the array of pixels 149. In some embodiments, as the first and second data 141, 143 are taken simultaneously in a measurement, the same data is provided by the first data and the second data. Thus, in some embodiments, the first data 141 and the second data 143 may be a single set of data, which may provide measured intensity data for all pixels of the pixel array. In some embodiments, the data acquisition device is configured to extract the first data 141 which includes data related to the spectrum of the sample and the second data 143 which includes data related to the reference sample, as the two spectra are spatially separated from each other and impinge on.

In some embodiments, as described before and as shown in FIGS. 1C and 1D, the data channel including the spectrum of the sample is detected in the vertical direction above the reference channel comprising the spectrum of the reference channel. Thus, in some embodiments, the data acquisition device 127 is configured to identify the first data 141, which includes data related to the spectrum of the sample, and the second data 143 based on the location on the array of pixels 149 where the data is collected.

As shown in FIGS. 1C and 1D, it is at least in some embodiments a small number of pixels, in particular a row of pixels or a small number of neighbouring rows of pixels, which detect higher intensity values with regard to the background. In particular, these pixels can be identified as providing the first data 141 and the second data 143 as at least most of the intensity distribution is detected in these pixels.

In some embodiments, the second data 143 can be used to wavelength calibrate the first data 141. As the second data 143 relates to the known spectrum of the reference sample, peaks in the spectrum relate to high intensity values measured at one or more pixels that registered the second data 143. For example, along the horizontal axis of the images shown in FIGS. 1C and 1D, a wavelength can be assigned to a pixel in dependence on its position along the horizontal axis (corresponding to the spectral direction of the spectra) based on the second data 143. Thereby, the intensity distribution over the pixels obtained in the first data 141 (data channel in FIGS. 1C and 1D) can be wavelength calibrated and a spectrum of the sample can be extracted.

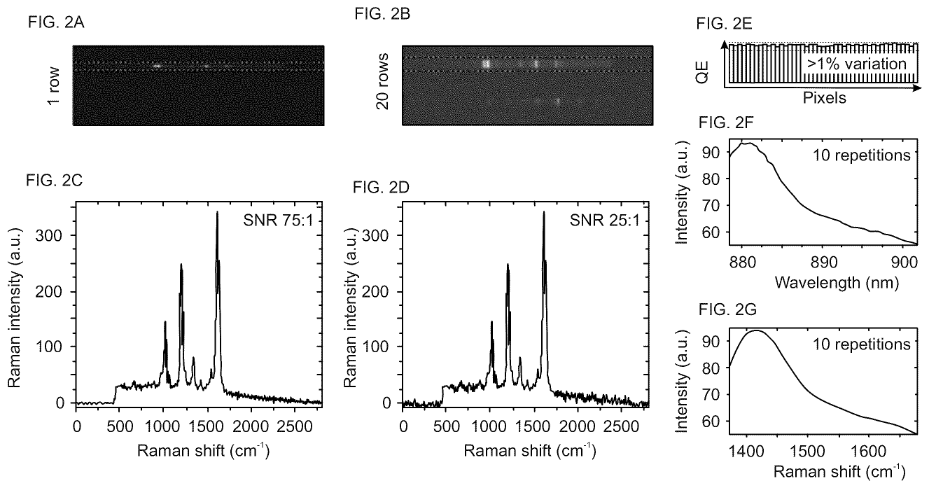

In some embodiments, the first data 141 and the second data 143 can be measured in different pixels from measurement to measurement in the sequence of measurements. More specifically, the intensity distributions which relate to the spectrum for the sample in the main/data channel and the reference spectrum for the reference sample in the reference channel may be obtained in different pixels from measurement to measurement in the sequence of measurements. In some embodiments, this can be realized by either moving the spectra with regard to the array of pixels 149 or moving the array of pixels 149 with regard to the incident spectra. As a result, a plurality of spectra that are related to the sample can be determined by the data acquisition device 127 in the sequence of measurements. For each measurement, the respective spectrum is detected by different pixels. An average spectrum can be determined based on the measured spectra. Thereby, a so-called pixel-to-pixel quantum efficiency variation (QE variation) can be averaged out or reduced. This results in an averaged spectrum for the sample, which has an improved signal to noise ratio (see also FIGS. 2A-2G and associated explanations below).

The data acquisition device 127 can be configured to output the averaged spectrum for the sample, either in form of corresponding data that can be stored on and read out from the storage device 145 of the data acquisition device or in visualized form on a display device, for example a display device 151 of the data acquisition device.

In some embodiments, the pixel array 149 can be divided into at least two regions, such that the first data 141 provides for each measurement an intensity value measured at a pixel for each pixel of one region, and the second data 143 provides for each measurement an intensity value measured at a pixel for each pixel of another region of the array of pixels. For example, as shown in FIGS. 1C and 1D, the pixel array 149 can be divided into an upper half and a lower half and the first data 141 is obtained in the upper half and the second data is obtained in the upper half. Thus, the data acquisition device 127 may distinguish the first data 141 from the second data 143 by the region in which the data is measured.

FIG. 2A and FIG. 2B demonstrate for at least some embodiments the sensitivity and quantification performance of the miniaturized Raman system as shown in FIG. 1A. Specifically, FIG. 2A and FIG. 2B each shows an image on the sensor of a SERS spectrum of a known sample, which is in this case BPE deposited on nano pillars based SERS substrate at a concentration of 100 μM.

The signals are measured with a laser spot size on the sample of 10 μm (FIGS. 2A) and 100 μm (FIG. 2B). In some embodiments, in order to achieve miniaturization without significant compromise on sensitivity, a sensor with a small binned pixel size of 4 μm is employed and the signal obtained from the Raman spectrum is obtained in a single row on the sensor using high numerical aperture (NA) imaging lens L6 (see lens L6 in FIG. 1A, see also the image of FIG. 2A).

Signal compression allows to maximize SNR per pixel and avoid averaging of additional rows with unwanted additional dark noise. This is illustrated in an experiment where equal amount of total intensity of SERS signal was distributed over 20 rows on the sensor (see FIG. 2B). A comparison of SERS spectra of trans-1,2-bis(4-pyridyl)ethane (BPE) shown in FIG. 2C and FIG. 2D highlights 3 times higher SNR when the SERS signal is compressed into a single row.

FIG. 2F represents a fluorescence spectrum from a glass cover slide excited by a laser (see second part of the split beam B2 on the sample in FIG. 1A) with an excitation wavelength of 785 nm obtained after averaging of 10 repetitions. It is visible that the spectral profile of fluorescence contains noise-like spikes. This “noise” is usually present no matter how long a spectrum is collected or how many repetitions are applied because it represents pixel-to-pixel QE variation. However, once the reference channel-based wavenumber calibration is applied, pixel-to-pixel QE variation is significantly reduced, which can in particular be seen in FIG. 2G. This happens because each spectrum wavenumber corresponds to a different pixel in the sensor row when the laser wavelength is shifted or at least allowed to shift, for example due to non-stabilized laser operation. As a result, pixel-to-pixel QE variation is averaged out over the pixels in the same row.

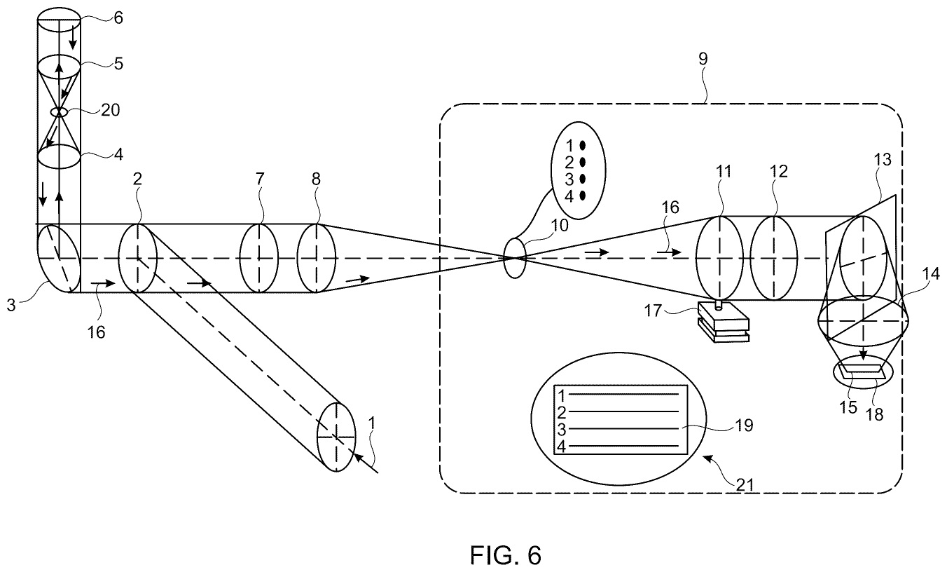

Embodiments of the method as described herein may be used also for sensor fringe compensation, if the laser spectral tuning is higher than a fringe period. An example of spectrum with a fringe shows FIG. 6. More details with regard to FIG. 6 are provided below.

In some embodiments, the data acquisition is based on shifting the spectrum of the laser beam along the sensor pixels using a tunable laser source. For example, a diode laser can shift the wavelength by changing the current that drives the diode laser. This may also case a change of temperature of the diode laser. Alternatively or additionally, a wavelength-tunable element, such as a grating, may be arranged in a set-up that stabilizes the respective diode laser.

Similar results may be reached in some embodiments, in which a sensor movement along rows or columns on the sensor pixels is employed, such that the incident spectra are detected in different measurements on different sensor pixels. In a movement, the position of the sensor is changed, but the movement only takes place in between measurements and not during a measurement.

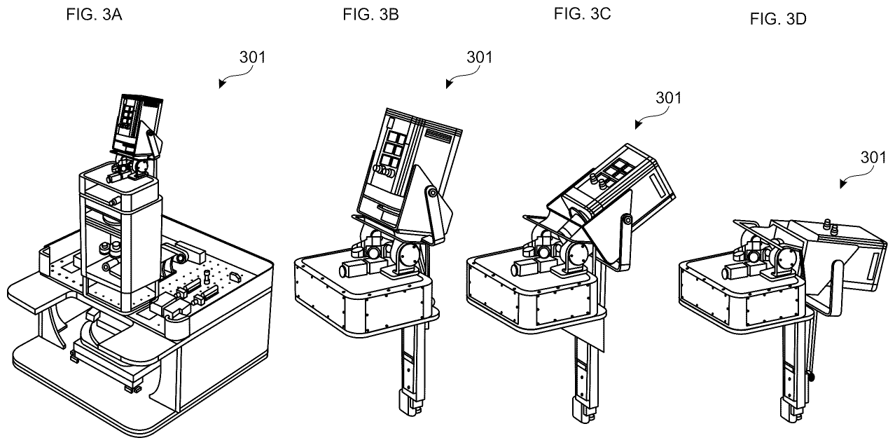

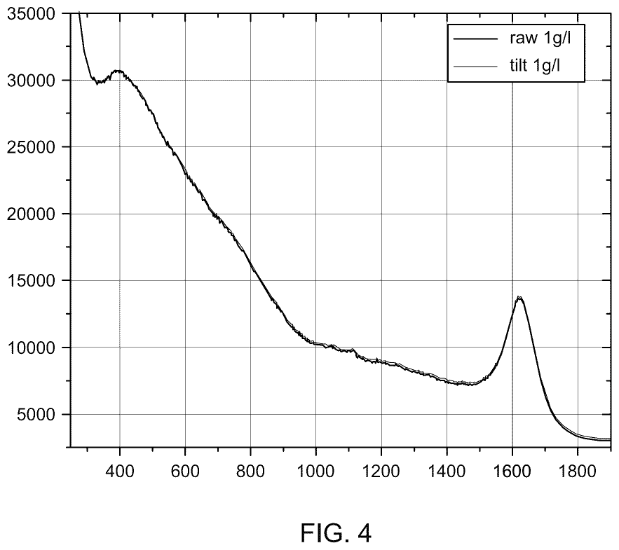

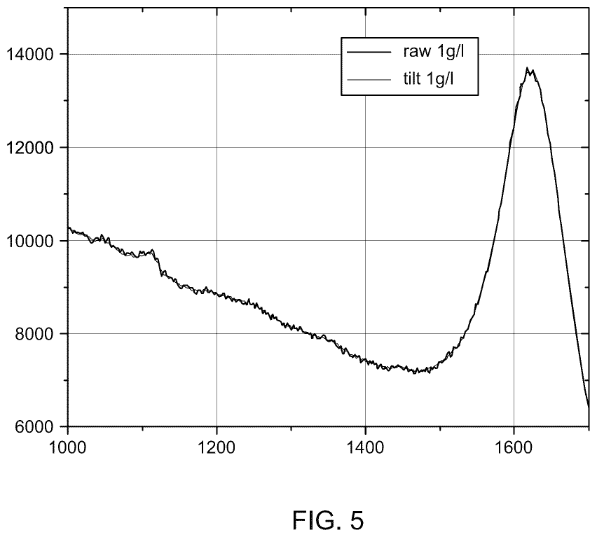

The apparatus of FIG. 1A may include in some embodiments a carrier 301 for the sensor as illustrated in FIGS. 3A-3D. In some embodiments, the carrier 301 is configured to move the sensor in at least one direction with regard to the spectra impinging on the sensor. The movement can include a rotation and/or a movement to an inclined position, in particular such that different pixels of the array of pixels are used for detection of the spectra in the main and reference channel.

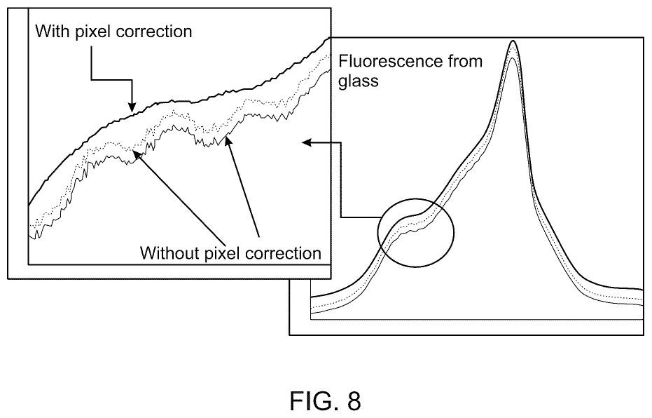

In some embodiments, a movement of the carrier 301 may be synchronized with the data acquisition, so that a movement of the sensor from one position to another position is only carried out in between measurements, but not during a measurement. As a result, pixel QE averaging after collection of several spectra at different sensor positions may be achieved. Embodiments of the described method may be used for sensor fringe compensation, if the sensor shift is higher than the fringe period, see spectrum with fringe in FIG. 8.

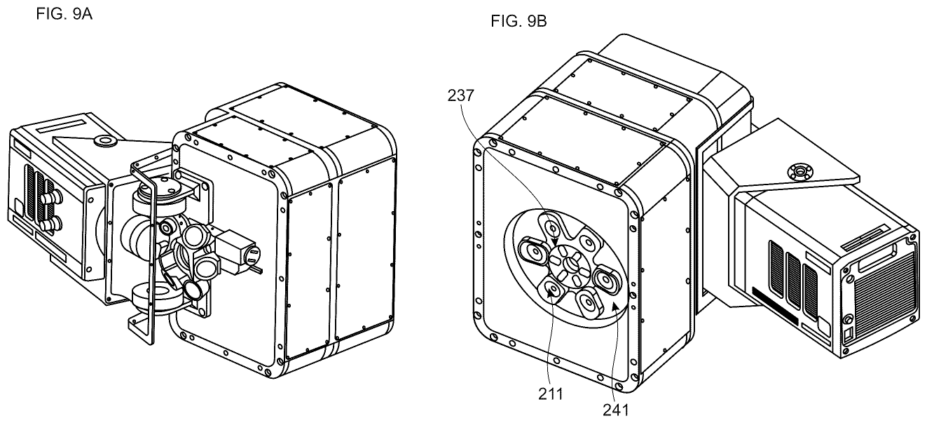

Referring to FIG. 6, it shows an exemplary embodiment of an apparatus for carrying out Raman spectroscopy. The optical system includes a dichroic mirror 2, a mirror 3, a lens arrangement 4, which can be a first objective, a lens arrangement 5, which can be a second objective, another mirror 6, a first edge filter 7, a slit lens 8, a spectrograph 9. The spectrograph 9 includes a slit 10, a collimation lens 11, a second edge filter 12, a transmission grating 13, a focusing lens 14, a motorized vertical translation stage 17 coupled to the collimation lens 11, a detector, which is an imaging sensor 18 having an array of pixels. A sample 20 to be analysed is arranged in the apparatus. The lens arrangement 5 and the mirror 6 may in some embodiments be removed, so that the sample 20 can be arranged outside of the apparatus, but in such a way that it can be exposed to a laser beam. The whole Raman spectrometer can be arranged in a housing (see FIGS. 9A-9B), with the option that the sample 20 can be located outside the housing. The sample 20 can be removed from the apparatus, and it can in particular be replaced by another sample of interest.

A laser beam 1 is provided by a laser source (not shown) of the apparatus. The laser source may be a diode laser. The laser beam 1 is guided and focused by the optical system (see dichroic mirror 2, mirror 3, lens arrangements 4, 5 and mirror 6) on the sample 20. Due to interaction between the sample 20 and the laser beam 1, a first spectrum beam is generated, in particular due to Raman scattering, which includes a spectrum which is characteristic for the sample 20, and that can pass through the dichroic mirror 2.

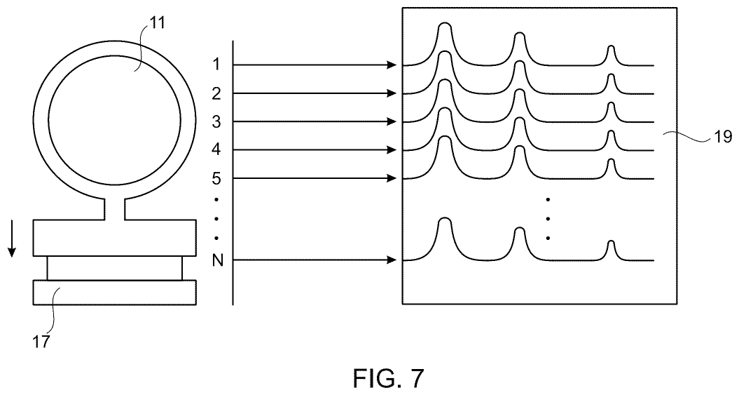

FIG. 6 shows in an enlarged view 21 an image of the pixel array from the imaging sensor 18. In the enlarged view 21, several lines are shown on the pixel array, which serve as an illustration for several Raman spectra 19 which are measured in consecutive measurements. The spectra 19 are referenced by numbers 1, 2, 3, and so on. Corresponding spectra 19 are shown in FIG. 7 for measurements 1, 2, 3, . . ., N.

In some embodiments, a data acquisition device, such as device 127 in FIG. 10, can be operatively coupled to the imaging sensor 18 and carry out the measurements 1, 2, 3. . . N. In some embodiments, the data acquisition device detects a spectrum 19 in a first set of pixels for example as referenced by the number 1 in FIGS. 6 and 7. In the next measurements, the data acquisition device detects a spectrum 19 in another first set of pixels as referenced by the number 2 in FIGS. 6 and 7. Thus, the first set of pixels in which an intensity distribution that is associated with the spectrum of the sample changes from measurement to measurement 1, 2. . . N as illustrated in FIGS: 6 and 7.

The spectrum can be moved from measurement to measurement by a controlled movement of the collimation lens 11 in a step-wise fashion using the translation stage 17. By determining the spectra from the intensity distributions measured in the different first sets of pixels and averaging the spectra to obtain an averaged spectrum, the effect of QE variation in the pixels can be reduced. Thereby, a spectrum of the sample with an improved signal to noise ration can be obtained.

The movement of the collimation lens 11 can in particular be controlled by the data acquisition device and it can be synchronized with the measurements of the spectra. In particular the collimation lens 11 may only be moved in between measurements and kept at a fixed position during a measurement. Moreover, in some embodiments, the movement may be such that the spectrum 19 moves by a predetermined number of pixels on the array of pixels.

In a modified embodiment, the design of FIG. 6 can include a reference sample as in the embodiment of FIG. 1A. The laser beam 1 can be split into two beams to obtain simultaneously a spectrum from the sample on a first set of pixels and a spectrum from the reference sample on another second set of pixels on the array of pixels for a measurement. As described before, the data obtained from the reference sample can be used to wavelength calibrate the data obtained for the sample.

In some embodiments, the optical system and in particular one or more focusing lenses in the optical system, such as slit lens 8 and focusing lens 14, can be designed such that it focusses or compresses the spectrum obtained on the array of pixels in the width direction, which is orthogonal to the spectral direction, to a width which is smaller, similar or slightly larger than the size of a pixel. Thus, the intensity in one spectrum can be distributed to a set of pixels that corresponds to a row of pixels or a small number of rows of pixels, such as 2 or 3 rows. This is advantageous as the sensitivity of the measurement may also depend on the dark noise in the pixels.

As explained before, in some embodiments, it is possible to shift a spectrum from measurement to measurement using a displacement of a lens or another optical element inside the spectrometer. In some embodiments, a focusing lens L7 used to focus the collected Raman spectra on the sensor is moveable, for example by a stepper motor, in a controlled way. In some embodiments, a collimation lens 11 for collimation of the beam after the slit lens 8 and the slit 10 as shown in FIG. 6 is coupled to a stepper motor.

As shown in FIG. 7, the stepper motor can be a motorized vertical translation stage 17. Due to a movement of the stepper motor, the positions where the collected spectra are incident on the sensor pixels can change, so that different pixels can be employed to collect spectra obtained from the same sample. As a result, pixel QE averaging after collection of several spectra at different sensor positions may be achieved.

In some embodiments, the spectra are collected via the moving of the collimation lens 11 in the Raman spectrograph of FIG. 6 in a vertical direction during Raman spectrum accumulation procedure. In some embodiments, a way of high quality Raman spectrum measurements requires a number of repetitions of spectrum acquisition by sensor. Considering that a Raman spectrum in an aberration corrected spectrograph occupies around one to five vertical imaging sensor pixels, each step of the collimation lens movement may be carried out such that the spectrum moves by a fixed number of vertical pixels (normally 1, 2 or 4 pixels per step) and the movement may be synchronized with the spectrum acquisition on the detector. An example is shown in FIG. 8, in which a portion of an obtained spectrum is shown with and without averaging over pixels.

In some embodiments, in order to reach a high SNR taking account of the mentioned different pixels sensitivity problem, the total number of repetitions can be as much as possible. In some embodiments, if the sensor has 256 pixels in the vertical dimension, the number of repetitions could be 256 with 1 pixel step size. In the case of solving a fringe problem, the number of repetitions should correspond to the period of the fringe at a specific wavelength. The fringe period is different from the length of the imaging sensor. Therefore, the number of repetitions may be adjusted depending on the wavelength range of interest.

The multi-purpose spectrometer shown in FIGS. 9A-9B includes transmission gratings which are arranged on a rotational turret or rotational wheel 241. A transmission grating that shall be used in the optical system can be moved in the respective light path by turning the turret. Thereby, the spectral range and resolution of the apparatus may be adapted and improved.

Furthermore, the sensor, which can be a camera, such as a CCD camera, is arranged on a carrier 301 by which the sensor can be rotated to obtain also high-resolution spectra with highly dispersive transmission gratings 211, in addition to the possibility to carry out artefacts-free measurements. In some embodiments the projected spectrum is larger than the size of the sensor. Thus, the length of the spectrum, seen in the spectral direction, may be larger than the size of the array of pixels of the sensor. Therefore, the sensor rotation is used to record the spectrum part by part. The sensor is rotated around the center of the respective grating. In some embodiments in which the spectrometer uses a reflective spectral grating, the grating may be rotated in order to record the spectrum part by part. However, transmission Bragg gratings as used in the shown embodiment work only with a fixed angle of incidence of the incoming light beam. Therefore, it is not possible to rotate them without deterioration of the spectrum. In some embodiments, for example as the one shown in FIGS. 9A-9B, the sensor is rotated while the transmission grating is fixed in order to record a spectrum part by part which is than the size of the sensor.

FIG. 11 shows a block diagram of an embodiment of an apparatus 201 for carrying out spectroscopy, in particular Raman spectroscopy, on a sample 203. The apparatus 201 is configured to obtain a spectrum beam 205 from an interaction between a laser beam 207 and the sample 203, which is arranged such that it can be illuminated by the laser beam 207. The spectrum beam 205 includes at least a portion of the spectrum which is characteristic for the sample due to the interaction process, which can be a Raman scattering process.

The apparatus 201 includes an optical system 209, which is configured to guide the spectrum beam 205 to a diffraction element 211 of the optical system 211. In some embodiments, the diffraction element 211 is a Bragg grating or a transmission Bragg grating. The diffraction element 211 is configured to split the spectrum beam 205 into a spectrum 213 of spatially separated wavelength components associated with the sample 209.

The apparatus 209 includes a detector 215 with an array of pixels 217 for detecting the spectrum 213 of spatially separated wavelength components on pixels 219 of the array of pixels 217. The wavelength components of the spectrum 213 are separated spatially, so that the wavelength components are separated from each other along a direction, a so-called spectral direction. The spectrum therefore extends in the plane of the pixel array in the spectral direction over a certain length, which is normally significantly greater than the pixel size. Different wavelength components of the spectrum are therefore detected in different pixels. In the direction perpendicular to the spectral direction, the spectrum can have a certain width, which can extend over one pixel size or over several pixel sizes. The intensity in a wavelength component will therefore be measured by one or more pixels, depending on how wide the spectrum is. The pixel field can therefore be used to measure an intensity distribution of the incident spectrum in at least some pixels, from which the spectrum of the sample can be determined. In some embodiments, the measured spectrum is compared with a plurality of stored spectra in the data acquisition device to identify the sample, if the measured spectrum matches with one of the stored spectra. Using such a comparison with a stored spectrum, a calibration of the measured spectrum may be carried out.

For carrying out measurements, the apparatus 201 includes a data acquisition device 221 coupled to the detector 215, in particular such that the optical signals detected by the detector 215 can be provided to the data acquisition device 221. The data acquisition device 221 is configured to carry out a sequence of measurements by use of the detector 215. During each measurement, data 223, such as the mentioned intensity distribution, which is indicative of the spectrum 213 of spatially separated wavelength components is obtained from the array of pixels 217 of the detector 215. In different measurements, the spectrum 213 of spatially separated wavelength components is detected on different pixels 219 of the array of pixels 217. The data acquisition device 221 is further configured to determine an averaged spectrum 225 of the sample 203 based on the data 219 obtained during at least some measurements and preferably during all measurements of the series of measurements.

The sample 203 is not part of the apparatus. It may be arranged as shown in FIG. 11 in the optical system 209 of the apparatus 201 such that it can be hit by the laser beam 207. The spectrum beam 205 generated by interaction between the laser beam 207 and the sample 203 can be guided by the optical system 203 via the diffraction element 211 to the detector 215. The spectrum beam 205 may only result from the portion of light scattered by the sample 203, which is picked up by the optical system 209 and guided to the detector 215.

As in some embodiments, the average spectrum 225 of the sample 203 is determined from the data 223 that is obtained during the measurements of the series of measurements on different pixels 219 of the array of pixels 217, pixel-to-pixel QE variation and other pixel specific errors may be averaged out or reduced. Therefore, the obtained average spectrum 225 of the sample 203 may have an improved signal to noise ratio. The average spectrum 225 may be obtained in form of digital data stored on a storage device of the data acquisition device 221 and the average spectrum can be visualized on a display 229 of the data acquisition device 221.

In some embodiments, the data acquisition device 221 is a computing system and includes one or more processors 231 that execute a computer program code to carry out the described sequence of measurements.

In some embodiments, the apparatus 202 is configured to move the spectrum 213 with respect to the array of pixels 217 in between consecutive measurements, such that different pixels 219 of the array of pixels 217 are hit by the spectrum 213 of spatially separated wavelength components in different measurements.

In some embodiments, the apparatus is configured to move the pixel array 217 of the detector 219 with regard to the incident spectrum 213 of spatially separated wavelength components in between consecutive measurements, such that different pixels 219 of the array of pixels 217 are hit by the spectrum 213 of spatially separated wavelength components in different measurements.

In some embodiments, the data acquisition device 221 is configured to control a movement of the spectrum beam 205 with respect to the array of pixels 217 in between consecutive measurements. In some embodiments, the data acquisition 221 device is configured to control the movement of the array of pixels 217 with regard to the incident spectrum 213. The movement may be controlled in such a way that from measurement to measurement, the spectrum is shifted by a defined distance, such as a defined number of rows, on the array of pixels 217, or that the detector 215 is moved or rotated in a defined distance or angle from measurement to measurement.

At least in some embodiments, the controlled movement of the spectrum 213 with respect to the array of pixels 217 or the movement of the pixel array 217 with regard to the incident spectrum 213 only takes place in between measurements. This may help to improve the signal to noise ratio of a detected signal, as the data is detected by the same pixels during a measurement, so that the intensity detectable per pixel is not smeared across several pixels.

In some embodiments, the laser beam 207 is provided by a laser 233. In some embodiments, the laser 233 is at least one of the following: a non-wavelength stabilized laser, a non-temperature stabilized laser, a tunable laser, a diode laser.

In some embodiments, the data acquisition device 221 is configured to change the wavelength of the laser beam 207. In some embodiments, the data acquisition device 221 is configured to measure the wavelength of the laser beam 207. In some embodiments, the laser 233 may be a wavelength tunable laser and the data acquisition device 221 may be coupled to the laser 233 such that it can control the wavelength of the laser beam 207.

In some embodiments, the apparatus includes a carrier 235 for the detector 215 (see also FIGS. 3 and 9). The carrier 235 is configured to move or rotate the detector 215 with regard to the incident spectrum of spatially separated wavelength components. In some embodiments, the carrier 235 is connected to the data acquisition device 221 such that the data acquisition device 221 may control the carrier 235 for moving or rotating the detector 215. The movement is usually carried out in between measurements, but not during a measurement.

In some embodiments, the carrier 235 is configured to rotate the array of pixels 217 with regard to a center of the diffraction element 211, which can be a transmissive Bragg grating. The center of the diffraction element 211 can form the center of a rotational movement of the detector 215, so that the distance between diffraction element 211 and detector 215 does not change. The movement of the detector 215 in between measurements can in particular be moved to detect a spectrum in a stepwise manner when the spectrum is larger than the size of the array of pixels.

In some embodiments, the apparatus includes a support for holding the diffraction element 211, wherein the support holds at least a second diffraction element 237 and is configured such that it can move the diffraction element 211 out of the optical system and position the second diffraction element 237 in the optical system (see FIG: 8).

In some embodiments, the support includes a rotatable wheel 241 having mountings for diffraction elements 211, 237 at different locations which are offset from each other as viewed in the circumferential direction of the rotatable wheel (see FIG. 8). The rotatable wheel 241 is arranged such that a diffraction element 211, 237, which is arranged in one of the mountings, can be positioned in the optical system by a rotational movement of the wheel. In some embodiments, the rotating wheel 241 is a turret.

In some embodiments, during operation of the apparatus, the spectrum of spatially separated wavelength components passes through at least one lens 243 of the optical system 209, such as a collimation or focusing lens. In some embodiments, the lens 243 is arranged between the diffraction element 211 and the detector 221 and the lens 243 is coupled to a drive 245, for example a stepper motor. The drive 245 is controlled by the data acquisition device 221 to cause a movement of the lens 243 by which the spectrum of spatially separated wavelength components can be moved with respect to the array of pixels 217 of the detector 215.

In some embodiments, the data acquisition device 221 is configured to control the drive 245 to synchronize the movement of the lens 243 with a measurement of the series of measurements.

In some embodiments, the diffraction element 211 spreads the spectrum 213 of spatially separated wavelength components in a spectral direction (corresponding to the horizontal axis in FIG. 1C and B). The optical system 209 is configured to compress a width direction (corresponding to the vertical axis in FIG. 1C and B) of the spectrum 213 to a predetermined width on the array of pixels 217. The width direction of the spectrum 213 is perpendicular to the spectral direction.

In some embodiments, the predetermined width is in the range of or corresponds at least approximately to a size of a pixel 219 of the detector 215 or a multiple of the pixel size. Thereby, the intensity provided by a wavelength range that falls within a pixel in the spectral direction can be concentrated in one pixel or in a small number of pixels adjacent to each other in the width direction. As the intensity is usually low, the signal to noise ration of the measured spectrum may be improved.

In some embodiments, the apparatus is configured to move the spectrum, for example by use of the drive 245, or the array of pixels 217, for example by use of the support 239 such that the spectrum 213 of spatially separated wavelength components is moved by a defined distance on the array of pixels 217. In some embodiments, the defined distance can correspond to a given number of rows of the array of pixels 217.

In some embodiments, the apparatus includes a reference sample (see also FIG. 1A and B) arranged in the optical system. The apparatus is configured to split a laser beam obtained from a laser in a first portion and a second portion. The first portion of the laser beam is the laser beam (see laser beam 207) used for the interaction with the sample 203 to obtain the spectrum beam 205, which is a first spectrum beam.

The apparatus further obtains a second spectrum beam from an interaction between the second portion of the laser beam and the reference sample. The optical system guides the second spectrum beam to the diffraction element, which splits the second spectrum beam into a reference spectrum of spatially separated wavelength components associated with the reference sample. The data acquisition device obtains, during each measurement, second data, which is indicative of the reference spectrum of spatially separated wavelength components from the array of pixels of the detector. In different measurements, the second data is obtained on different pixels than the first data obtained for the spectrum of the sample. The data acquisition device uses the second data obtained in a measurement for calibrating the data obtained in the same measurement for the spectrum of spatially separated wavelength components of the sample.

The term “store,” “stored,” “storing,” or any variation thereof may refer to saving data in any computer readable medium.

The term “computer-readable medium” refers to any available medium that can be accessed by a computing device or processor. By way of example, and not limitation, such a medium may include RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. A computing device or may store and/or retrieve data from a computer-readable medium as described herein.

The term “computing device” as used herein includes mobile, portable, and/or handheld devices, including but not limited to laptops, tablets (including medical grade tablets), smartwatches and other wearable devices, mobile telephones, and smartphones. The term “computing device” may also include a computer such as a desktop computer, or server.

Although particular features have been shown and described, it will be understood that they are not intended to limit the claimed invention, and it will be made obvious to those skilled in the art that various changes and modifications may be made without departing from the spirit and scope of the claimed invention. The specification and drawings are accordingly to be regarded in an illustrative rather than restrictive sense. The claimed invention is intended to cover all alternatives, modifications and equivalents.

1. An apparatus for carrying out spectroscopy, in particular Raman spectroscopy, on a sample, the apparatus being configured to obtain a spectrum beam from an interaction between a laser beam and a sample, which is arranged in the apparatus;
the apparatus comprising an optical system configured to guide the spectrum beam to a diffraction element of the optical system,
the diffraction element being configured to split the spectrum beam into a spectrum of spatially separated wavelength components associated with the sample;
the apparatus comprising a detector with an array of pixels for detecting the spectrum of spatially separated wavelength components on pixels of the array of pixels and a data acquisition device coupled to the detector;
the data acquisition device being configured:
to carry out a sequence of measurements using the detector, wherein during each measurement data which is indicative of the spectrum of spatially separated wavelength components is obtained from the array of pixels of the detector, wherein in different measurements the spectrum of spatially separated wavelength components is detected on different pixels of the array of pixels, and
to determine an averaged spectrum of the sample based on the data obtained during at least some measurements and preferably during all measurements of the series of measurements.

2. The apparatus of claim 1,
wherein the apparatus is configured to carry out at least one of the following:
to move the spectrum with respect to the array of pixels in between consecutive measurements, such that different pixels of the array of pixels are hit by the spectrum in different measurements;
to move the pixel array of the detector with regard to the incident spectrum of spatially separated wavelength components in different measurements, such that different pixels of the array of pixels are hit by the spectrum of spatially separated wavelength components in different measurements.

3. The apparatus of claim 2,
wherein at least one of the following is controlled by the data acquisition device: the movement of the spectrum with respect to the array of pixels in between consecutive measurements and the movement of the pixel array of the detector with regard to the incident spectrum.

4. The apparatus of claim 3,
wherein the movement only takes place in between measurements.

5. The apparatus of claim 1,
wherein the laser beam is provided by a laser, wherein, optionally, the laser is at least one of the following: a non-wavelength stabilized laser, a non-temperature stabilized laser, a tunable laser, a diode laser.

6. The apparatus of claim 1,
wherein the data acquisition device is configured to change the wavelength of the laser beam.

7. The apparatus of claim 1,
wherein the apparatus comprises a carrier for the detector, wherein the carrier is configured to move or rotate the detector with regard to the incident spectrum of spatially separated wavelength components, wherein, optionally, the carrier is connected to the data acquisition device and the data acquisition device is configured to control the carrier.

8. The apparatus of claim 7,
wherein the carrier is configured to rotate the array of pixels and wherein the diffraction element comprises a center, wherein the rotation is carried out around the center of the diffraction element.

9. The apparatus of claim 1,
wherein the apparatus comprises a support for holding the diffraction element, wherein the support holds at least one further diffraction element and the support is configured to move the diffraction element out of the optical system and position the further diffraction element in the optical system.

10. The apparatus of claim 1,
wherein the support comprises a rotatable wheel having mountings for diffraction elements at different locations which are offset from each other as viewed in the circumferential direction of the rotatable wheel, and wherein the rotatable wheel is arranged such that a diffraction element, which is arranged in one of the mountings, can be positioned in the optical system by a rotational movement of the wheel.

11. The apparatus of claim 1,
wherein the spectrum of spatially separated wavelength components passes through at least one lens, such as a collimation or focusing lens, of the optical system, the lens being arranged between the grating and the detector and the lens being coupled to a drive for changing the position of the lens, for example a stepper motor, wherein a change of the position of the lens causes a movement of the spectrum of spatially separated wavelength components with respect to the array of pixels of the detector.

12. The apparatus of claim 11,
wherein the data acquisition device is configured to control the drive to synchronize the change of position of the lens with a measurement of the series of measurements.

13. The apparatus of claim 1,
wherein the diffraction element spreads the spectrum of spatially separated wavelength components in a spectral direction, and the optical system is configured to compress a width direction of the spectrum to a predetermined width on the array of pixels, wherein the width direction of the spectrum is perpendicular to the spectral direction.

14. The apparatus of claim 13,
wherein the predetermined width is in the range of or corresponds to a size of a pixel of the detector or a multiple of the pixel size, wherein a multiple is in the range of 1 to 50 times the pixel size.

15. The apparatus of claim 2,
wherein the apparatus is configured to move the spectrum or the array of pixels such that the spectrum of spatially separated wavelength components is moved by a defined distance on the array of pixels.

16. The apparatus of claim 1,
wherein the apparatus comprises a reference sample arranged in the optical system, the apparatus being configured to split the laser beam in a first portion and a second portion, the first portion of the laser beam being the laser beam used for the interaction with the sample to obtain the spectrum beam, which is a first spectrum beam,
the apparatus being further configured to obtain a second spectrum beam from an interaction between the second portion of the laser beam and the reference sample and the optical system being configured to guide the second spectrum beam to the diffraction element, which splits the second spectrum beam into a reference spectrum of spatially separated wavelength components associated with the reference sample;
the data acquisition device being configured:
to obtain, during each measurement, second data which is indicative of the reference spectrum of spatially separated wavelength components from the array of pixels of the detector, wherein in different measurements the second data is obtained on different pixels than the first data obtained for the spectrum of the sample; and
to use the second data obtained in a measurement for calibrating the data obtained in the same measurement for the spectrum of spatially separated wavelength components of the sample.

17. A computer implemented method of carrying out spectroscopy, in particular Raman spectroscopy, on a sample, using an apparatus configured to obtain a spectrum beam from an interaction between a laser beam and a sample, the apparatus comprising an optical system configured to guide the spectrum beam to a diffraction element of the optical system, the diffraction element being configured to split the spectrum beam into a spectrum of spatially separated wavelength components associated with the sample, and the apparatus comprising a detector with an array of pixels for detecting the spectrum of spatially separated wavelength components on pixels of the array of pixels and a data acquisition device coupled to the detector,
wherein the method comprises:
carrying out a sequence of measurements using the detector, wherein in each measurement a set of obtaining data, by use of the array of pixels, which is indicative of the spectrum of spatially separated wavelength components is carried, wherein in different measurements the spectrum of spatially separated wavelength components is detected on different pixels of the array of pixels, and
determining an averaged spectrum of the sample based on the data obtained during at least some measurements and preferably during all measurements of the series of measurements.

18. An apparatus for carrying out spectroscopy, in particular Raman spectroscopy, on a sample,
the apparatus being configured to obtain a spectrum beam from an interaction between a laser beam and a sample, which is arranged in the apparatus;
the apparatus comprising an optical system configured to guide the spectrum beam to a diffraction element of the optical system,
the diffraction element being configured to split the spectrum beam into a spectrum of spatially separated wavelength components associated with the sample, wherein the diffraction element comprises a center;
the apparatus comprising a detector with an array of pixels for detecting the spectrum of spatially separated wavelength components on pixels of the array of pixels and a data acquisition device coupled to the detector;
the data acquisition device being configured to carry out a sequence of measurements using the detector, wherein, during each measurement, data which is indicative of the spectrum of spatially separated wavelength components is obtained from the array of pixels of the detector,
wherein the detector is arranged on a support which is rotatable around the center of the diffraction element in between measurements.
